(19) United States
(12) Patent Application Publication
(10) Pub. No.: US 2013/0191647 A1
(43) Pub. Date: Jul. 25, 2013

(54) Secure Wireless Access to Medical Data

(71) Applicants: Michael N. Ferrara, JR., Hillsborough, NJ (US); Peter J. Begley, Boston, MA (US); Jill Gora, Oldwick, NJ (US); Peter R. Rogina, Bridgewater, NJ (US)

(72) Inventors: Michael N. Ferrara, JR., Hillsborough, NJ (US); Peter J. Begley, Boston, MA (US); Jill Gora, Oldwick, NJ (US); Peter R. Rogina, Bridgewater, NJ (US)

(21) Appl. No.: 13/747,950

(22) Filed: Jan. 23, 2013

Related U.S. Application Data
(60) Provisional application No. 61/589,553, filed on Jan. 23, 2012.

(51) Int. Cl. G06F 21/32

(52) U.S. Cl. CPC G06F 21/32
USPC 713/186

(57) ABSTRACT

A method is disclosed that allows secure access to medical data. A device application running on a wireless device, optionally including associated scanners, acquires a patient's biometric information (e.g., a finger-print at a resolution exceeding 250 ppi using the display as a proximity flash-camera). An encrypted representation of the biometric data is wirelessly transmitted to a secure data center. A server application at the remote data center decrypts the data and compares it to a database for positive identification purposes. Relevant pre-approved medical data for the identified patient is automatically retrieved from a secure database of patient information, encrypted and sent to the wireless device by the server application. The received data is decrypted by the device application and displayed by the wireless device for use by the medical practitioner. The patient may also maintain and update his/her medical record through this method and device.

### CLAIM OF PRIORITY

This utility patent application claims priority from U.S. provisional application 61/589,553 filed on Jan. 23, 2012, the contents of which are herein fully incorporated by reference.

### FIELD OF THE INVENTION

The invention relates to methods of securely accessing and distributing confidential data, and particularly to using a mobile device as a secure platform for accessing and distributing medical data.

### BACKGROUND OF THE INVENTION

Many types of confidential information, including financial records, need to be accessed or distributed securely, and there are many established encryption and identification systems designed to facilitate this flow of information. Medical data, however, poses some special problems. For instance, every year, an estimated 1 million people in the US arrive at an emergency room unconscious, or unable to talk, and may have no clear means of identification. The ER staff, therefore, may not be able to quickly obtain details of the patient's medical history. This lack of information often delays a correct diagnosis of the patient's condition and can result in inappropriate treatment.

An object of this invention is to provide methods and systems to allow rapid, but secure, access to approved medical records in such emergency situations, as well as to enable quick, confidential transference of electronic medical files in more routine situations, such as obtaining files from an old practice when a patient attends a new practice for the first time.

In one embodiment of this invention, use is made of the fact that smartphones or tablets having high resolution organic light emitting diode (OLED) displays are now widely available, and are routinely carried by many health care staff. These smart phones, either standalone or equipped with accessory equipment, may be used to provide both simple and secure patient identification and to obtain and display their relevant medical history.

The patient identification method relies on an established, but often overlooked property of LEDs and OLEDs—that they can act as light absorbers as well as light emitters. However, as a reminder, Dietz et al. in an article entitled “Very Low-cost Sensing and Communication Using Bidirectional LEDs”, International Conference on Ubiquitous Computing, October 2003, details how, by suitable voltage biasing, an LED can be used both to emit and to absorb. Using this insight, a smartphone or tablet device with a sufficiently high resolution OLED screen, may be programmed to act as a fingerprint detector.

To be useful for identification, a digital image of a finger print has to have a resolution of at least 250 ppi. Smartphones are now available with OLED displays have resolutions of over 330 ppi. With encrypted wireless access to a suitable database, a smartphone may be used as a secure, biometric identification device. The smartphone's encrypted wireless access may then be used to securely obtain the relevant medical information.

The relevant prior art involving access to electronic medical records includes:

U.S. Pate. No. 6,022,315 issued to Iliff on Feb. 8, 2000 entitled “Computerized medical diagnostic and treatment advice system including network access” that describes a system and method for providing computerized, knowledge-based medical diagnostic and treatment advice. The medical advice is provided to the general public over networks, such as a telephone network or a computer network. The invention also includes a stand-alone embodiment that may utilize occasional connectivity to a central computer by use of a network, such as the Internet. Two new authoring languages, interactive voice response and speech recognition are used to enable expert and general practitioner knowledge to be encoded for access by the public. “Meta” functions for time-density analysis of a number of factors regarding the number of medical complaints per unit of time are an integral part of the system. A re-enter feature monitors the user's changing condition over time. A symptom severity analysis helps to respond to the changing conditions. System sensitivity factors may be changed at a global level or other levels to adjust the system advice as necessary.

U.S. Pat. No. 6,988,075 issued to Hacker on Jan. 17, 2006 entitled “Patient-controlled medical information system and method” that describes an electronic medical record system and service is disclosed for centrally storing patient's medical records electronically on a database for patient-controlled remote access by both patients and medical providers. The system stores a plurality of patient medical records on a medical information database via a medical information server connected to a network. A plurality of medical provider computers connected to the network have software to communicate with the medical information server. Patients supply authorization means to allow medical provider computers to access patient-selected portions of the patient's medical record for viewing and updating of the patient's medical record. Additionally, patients can access all portions of their medical record using browser software on any browser-enabled device connected to the network.

US Patent Application no. 20100094657 by D. E. Stern published on Apr. 15, 2010 entitled “Method and System for Automated Medical Records Processing” that describes a method and system for automated medical records processing. The method and system includes plural electronic medical templates specifically designed such that they reduce the complexity and risk associated with collecting patient encounter information, creating a medical diagnosis and help generate the appropriate number and type medical codes for a specific type of medical practice when processed. The medical codes and other types of processed patient encounter information are displayed in real-time on electronic medical records and invoices immediately after a patient encounter.

US Patent Application no 20080146277 R. L. Anglin et al. published on Jun. 19, 2008 entitled “Personal healthcare assistant” that describes methods and apparatus for providing remote healthcare are disclosed. One embodiment of the present invention comprises a transceiver that includes a camera, a display, a speaker, a microphone and embedded remote control. This transceiver may be used at home, at work, while traveling or in any other location that offers wired or wireless access to a network, such as the Internet or a cellular telephone system. The transceiver may be used to obtain information, treatment or medical care from a Healthcare provider. In one embodiment, the transceiver includes diagnostic and treatment software. In another alternative embodiment, the invention may also include a variety of data devices which are connected to the cellular phone over a wired or wireless connection. In one embodiment, a healthcare provider or healthcare facility may partially or jointly control the transceiver and/or a data device.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a method for securely accessing medical data.

In a preferred embodiment, a device application runs, or operates, on a wireless device that may have a light emitting diode (LED) display. The device application may include instructions that enable the wireless device to perform functions such as, but not limited to:
acquiring a representation of a patient identifier,
encrypting the representation,
wireles sly transmitting the encrypted representation to a secure data center, and
receiving patient medical data back from the data center.

In a preferred embodiment, the patient identifier may be, but is not limited to, a representation of a patient's finger-print. The representation of the finger-print preferably has a resolution of 250 pixels per inch or greater, and more preferably 500 pixels per inch.

The wireless device may then encrypt the representation to provide an encrypted representation that may be wirelessly, but securely, transmitted to a remote secure data center server.

The wireless device may then receive medical data back from the remote secure data server. The received medical data may be representative of a patient who may have been automatically identified using the finger-print representation. The identification may, for instance, be performed by a server application on the remote secure data center server by searching for a match to one of a database of recorded finger prints. Having identified the patient, relevant medical data may have been automatically retrieved from a secure database of patient information by the server application. This method is not only suitable for emergency care and regular medical treatments, the patient may also use the wireless device to maintain and keep current his/her electronic medical record. After retrieving the medical data from the secure database, the patient may review the data to determine if all updates have been performed. In some cases, with proper authorization, the patient may conduct the data inputting activities and keep the record current and complete.

The received medical data is preferably in encrypted form, and may be decrypted by the device application running on the wireless device.

Depending on the application, the decrypted data may either be relayed to a local secure server or it may be displayed by the wireless device, in a suitable human accessible form.

Therefore, the present invention succeeds in conferring the following, and others not mentioned, desirable and useful benefits and objectives.

It is an object of the present invention to provide quick, secure and confidential access to a patient's records in both emergency and non-emergency situations.

It is another object of the present invention to provide a self-registering enrollment option in a medical data management system.

Yet another object of the present invention is to provide an identification system that operates on a suitable smartphone without additional hardware.

Still another object of the present invention is to provide timely medical information directly to the point of care.

Yet another object of the present invention is to provide an identification system that allows a patient to maintain and keep current his/her electronic medical record.

Still another object of the present invention is to leverage existing LED display technology on smartphones to provide fingerprinting capability.

### BRIEF DESCRIPTION OF THE DRAWINGS

FIG. 1 shows a schematic overview of a method for securely accessing medical data.

FIG. 2 shows a schematic flow diagram of some of the steps of a method for securely accessing medical data that may be performed on a wireless device.

FIG. 3 shows a schematic flow diagram of some of the steps of a method for securely accessing medical data that may be performed on a remote server.

FIG. 4A shows a positively biased Light Emitting Diode (LED) producing emitted light.

FIG. 4B shows a reverse biased Light Emitting Diode (LED) absorbing light.

FIG. 5 shows an organic light emitting display (OLED) matrix display that may be used to capture a fingerprint.

FIG. 6 shows a schematic flow diagram of some of the steps of a modified method for securely accessing medical data.

### DESCRIPTION OF THE PREFERRED EMBODIMENTS

The preferred embodiments of the present invention will now be described with reference to the drawings. Identical elements in the various figures are identified with the same reference numerals.

Such embodiments are provided by way of explanation of the present invention, which is not intended to be limited thereto. In fact, those of ordinary skill in the art may appreciate upon reading the present specification and viewing the present drawings that various modifications and variations can be made thereto.

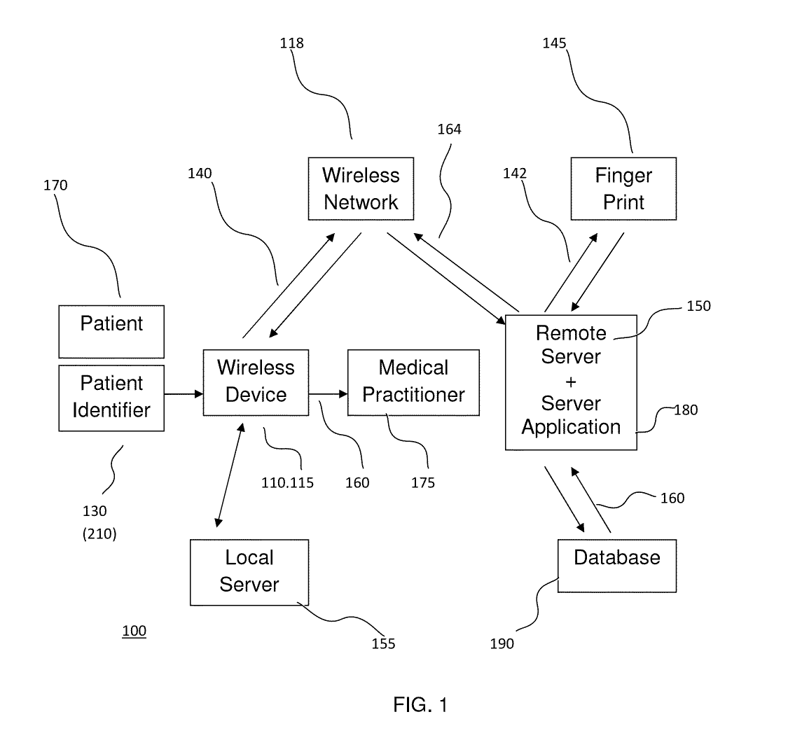

FIG. 1 shows a schematic overview of a method for securely accessing medical data 100.

As shown in FIG. 1, the method for securely accessing medical data 100 may, for instance, be used in an Emergency Room (ER) situation. In one scenario, a patient 170 may be admitted without identification and in a condition in which they are unable to communicate. In order to make a rapid and accurate diagnosis of the condition of the patient 170, the medical practitioner 175 in attendance would be greatly helped by having access to medical data 160 relevant to the patient such as, but not limited to, the patient's recent medical history and any medications they are currently prescribed.

The medical practitioner 175 may have a wireless device 115 running a device application 110 of this invention. The medical practitioner 175 may then use the wireless device 115 to both identify the patient and to obtain relevant medical data from a secure database of patient medical data 190.

The wireless device 115 here serves as an example for an electronic device on which the device application 110 may be implemented. Aside from a wireless device 115, the electronic device may be any kind of apparatus with computational capacities and connections to other devices. As long as the electronic device satisfies the basic requirements stated below, any kind of device may be considered to be under the coverage of the current invention. The wireless device 115, may, for instance, be a portable platform such as, but not limited to, a cell phone with or without a camera, a smart phone with or without a camera, a personal data assistant (PDA) with or without a camera, a tablet computer with or without a camera, a laptop with or without a camera, an e-reader with or without a camera or some combination thereof. The wireless device 115 may be connected to a network through various standards such as but not limited to: Wireless Personal Area Network, such as Bluetooth™, Wireless Local Area Network, such as Wi-Fi, Wireless Mesh Network, Wireless metropolitan area network, Wireless Wide Area Network, Cellular Network, and other similar securable data sharing network.

The wireless device 115 may include a biometric sensor and the biometric sensor may be used to acquire the representation of a patient identity. In a preferred embodiment, the wireless device 115 is preferably a wireless smartphone, and more preferably a wireless smartphone having a light emitting diode (LED) or organic light emitting diode (OLED) matrix display with a screen resolution greater than or equal to 250 ppi. As will be described later, such a screen may be used by a suitably programmed application to obtain the representation of a patient identity, such as a print from a finger placed directly on the screen. With the appropriate resolution screen, a finger-print of sufficient quality, i.e., a representation of the finger print 210 at a resolution of 250 ppi or greater, may be obtained for use in identifying the patient. Alternatively, the wireless device 115 may be connected to an external biometric sensor either directly or via wireless connection to augment the biometric scanning functions.

The device application 110 may also include coding to allow the wireless device 115 to then encrypt the representation of a patient identifier 130, i.e., the patient's finger-print. An encrypted representation 140 of the patient identifier 130 may then be transmitted via a wireless network 118 to remote secure data center server 150. A server application 180 running at the remote secure data center server 150 may be programmed to enable the server to first authenticate the wireless device 115. Once the wireless device 115 has been authenticated, the server application 180 may then decrypt the encrypted representation 140 to produce a decrypted representation 142.

The decrypted representation 142 may be used by the server application 180 to automatically query a database of recorded finger prints 145 to obtain the identity of the patient 170.

Having obtained the patient's identity, the server application 180 may then automatically retrieve medical data 160 that is relevant to the patient from the secure database of patient medical data 190. The server application 180 may encrypt this medical data and may then transmit the encrypted medical data 164 back via the wireless network 118 to the wireless device 115.

The wireless device 115 may then decrypt the encrypted medical data 164 and display the medical data 160 so that the medical practitioner 175 may make use of the information in their diagnosis and treatment of the patient.

In a further, preferred embodiment, the wireless device 115 may instead relay the encrypted medical data 164 on to a local secure server 155 for later decryption and use. In specific situations, the wireless device 115 may also receive medical data pre-loaded on a local secure server 155.

One of ordinary skill in the art will readily appreciate that although the scenario described above made use of finger prints, such a system may use any suitable biometric such as, but not limited to, iris patterns, face patterns, whole hand patterns or some combination thereof. In fact, the biometric may be any kind of imeagable or other biometric data capable of playing a role in determining the patient's identity. For instance, the voice of the patient may also be considered a biometric that may be used for identification.

Similarly, although an OLED screen has been described as the preferred method for obtaining the patient identifier, the finger-print, or other biometric, may be obtained by any suitable method such as, but not limited to, a camera, a sufficiently high resolution touch screen, a sufficiently high resolution haptic feedback screen or some combination thereof.

It should also be noted that there may be variations based on the embodiment shown above in FIG. 1. For example, the electronic device, as represented by wireless device 115, may also be used to perform the identification process. In summary, the device for the automatic identification may be considered a processing server. In embodiment shown in FIG. 1, the processing server is the remote secure server 150. However, as indicated above, the processing server may be the electronic device (thus the wireless device 115), or a local server that is connected to the electronic device. After the identification of the patient, the electronic device or local servers transmits an identification confirmation signal to the remote secure data server 150, wherein the remote server 150 may send the encrypted medical data to the wireless device 115, followed by the decryption of the medical data and possibly display of the data.

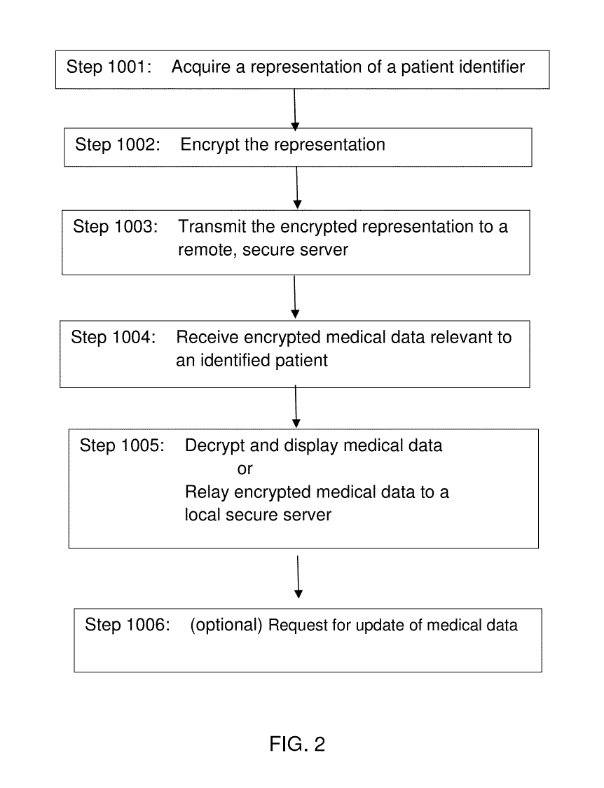

FIG. 2 shows a schematic flow diagram of some of the steps of a method for securely accessing medical data that may be performed on a wireless device.

Step 1001: Acquire a representation of a patient identifier. In this first step that may be performed by a suitably programmed wireless device 115, a suitable representation of a patient identifier 130 may be obtained.

In a preferred embodiment, the identifier may be a finger-print. For a digital finger-print to be useful in identification, the resolution of the digital image should be at least 250 ppi according to A. K. Jain in an article entitled “Pores and Ridges: High Resolution Fingerprint Matching Using Level 3 Features”, IEEE Transactions on Pattern Analysis and Machine Intelligence, Vol. 29, No. 1, pp. 15-27, January 2007. They also state that the Federal Bureau of Investigation (FBI) digital finger-print database requires 500 ppi resolution. The camera or other sensing devices, either directly associated with the electronic device or linked to the electronic device, may possess pre-processing capabilities so that the sensed biometric data can be pre-processed for further encryption and use.

In a preferred embodiment, the finger-print may be captured directly from a smartphone's OLED display using a suitably programmed device application 110. Such a print may instead be captured directly or indirectly by other means such as, but not limited to, a camera on a smart phone, a bar-code scanner, a high resolution haptic touch screen, a high resolution capacitance touch screen, a high resolution piezo-electric touch screen and a high resolution capacitance touch screen, or some combination thereof.

Step 1002: Encrypt the representation. In step 1002, the wireless device 115 may be used by a suitably programmed device application 110 to encrypt the representation of a patient identifier 130, i.e., the image of the finger-print 210. In a preferred embodiment, the encryption may use a well-known public-key encryption system such as, but not limited to, the well-known RSA encryption algorithms.

Step 1003: Transmit the encrypted representation to a remote, secure server. In step 1003, the wireless device 115 may be used by the device application 110 to wirelessly transmit the encrypted representation 140 of the representation of a patient identifier 130 to a remote secure data center server 150. The wireless transmission may be made via a suitable wireless network that may include elements such as, but not limited to, cellphone connections, WiFi connections BlueTooth connections and landline connections, or some combination thereof. However, it should be noted that this step is unnecessary or mechanically different when the identification process is performed not by the remote secure server, but by a local server or by the wireless device 115, as indicated above. Besides using a wireless transmission, the wireless device 115, as representative of all kinds of electronic devices that may acquire biometric data, may use wire connections to transmit the encrypted representation to a local server. In addition, when the electronic device itself is capable of performing the identification process, the transmittal of the encrypted representation happens only internally.

Step 1004: Receive encrypted medical data relevant to an identified patient. In step 1004, the wireless device 115 may be used by the device application 110 to receive the encrypted medical data 164 that is relevant to the patient 170. The encrypted medical data 164 preferably includes the patient's identity and any information that may help corroborate the identity such as, but not limited to, age, sex, height, ethnicity, hair color, eye color, known scars and known tattoos, or some combination thereof.

In the event of an apparent mistaken identity, the database may be re-queried by returning to step 1001 and re-acquiring the representation of a patient identifier 130. Alternately, the database may be re-queried by returning either to step 1002 and re-encrypting the original, or to step 1003 in which the originally encrypted representation is simply resent to the remote secure data center server 150.

The identification may be made to a single patient. Alternatively, the identifier may point to a group of associated individuals, e.g. persons in a single household. The patients, by himself/herself or with the assistance and permission of others, may pre-set the identification process so that a single identification provides access not only the patient's own medical data, but also to medical data of others. For example, an adult parent may set the current system so that a positive identification using the parent's biometric identifier may allow the access a child's medical data.

Step 1005: Decrypt and display medical data—or—Relay encrypted medical data to a local secure server.

In a preferred embodiment, being used in an ER situation, the device application 110 may use the wireless device 115 to decrypt the encrypted medical data 164. The device application 110 may then use the wireless device 115 to display the decrypted information. This information display is preferably in a human accessible form such as, but not limited to, a human readable alpha-numeric script, an audio, an image or a video, or a combination thereof. The medical practitioner 175 may then make use of the information in diagnosis and treatment of the patient.

In a further preferred embodiment, preferably a non-ER situation, such as, but not limited to, a patient making a first visit to a new medical practice, the system may be used to quickly and accurately populate a local server with the patient's medical history from a previous practice or from a central database. In this embodiment, the device application 110 may instruct the wireless device 115 to relay the encrypted medical data 164 on to a local secure server 155 without decrypting it.

To facilitate the decryption process, after the identification process by the processing server using the encrypted representation; a decryption key for the medical data only may be generated only if the positive identification is made. Preferably, the decryption key is encrypted together with the representation of a patient identifier. The decryption key may be time coded with an expiration time. After the expiration time, the decryption key is no longer effective and another positive identification must be made for proper decryption. A GPS element or WiFi connections, either independent or associated with another device, can also be used to further limit the decryption process. Such parameter may be used in combination and/or with the biometric identifier, providing extra security control for the access to the medical data.

Besides biometric identifiers, the decryption process may also be initiated by other means, such as inputting a password using a key board associated with the electronic device. The password needs to be pre-set by the patient or authorized by the patient.

After the encrypted medical data is decrypted, the decrypted data may be displayed on a local server or on the wireless device 115. The patient may determine and configure how the decrypted medical data may be properly displayed and what data may be displayed.

Step 1006: Request for update of medical data. In a further preferred embodiment, the patient may examine the medical record displayed so that he/she may determine whether the record is up to date. This may be conducted in any medical situation, except for extreme emergencies when the patient is unable to do so. If the patient finds the medical data to be not up to date, he/she may send in a request to update it. In addition, with proper input accessories, the patient may even be able to update the medical record himself/herself. It should be noted that the patient may pre-set who, besides himself/herself, may be allowed to update the medical information. For example, the patient may allow a health care professional to send the request of updating the medical data and complete the update process. In addition, the system may send notification to identified medical professionals if a positive ID is validated. Such a notification process may be configured by the patient. In general, update is only requested after the patient and/or an identified health professional examine the medical data already received and determines that there is inadequacy in the received data. Preferably, update does not cover distinct unrelated information such as doctor's appointments.

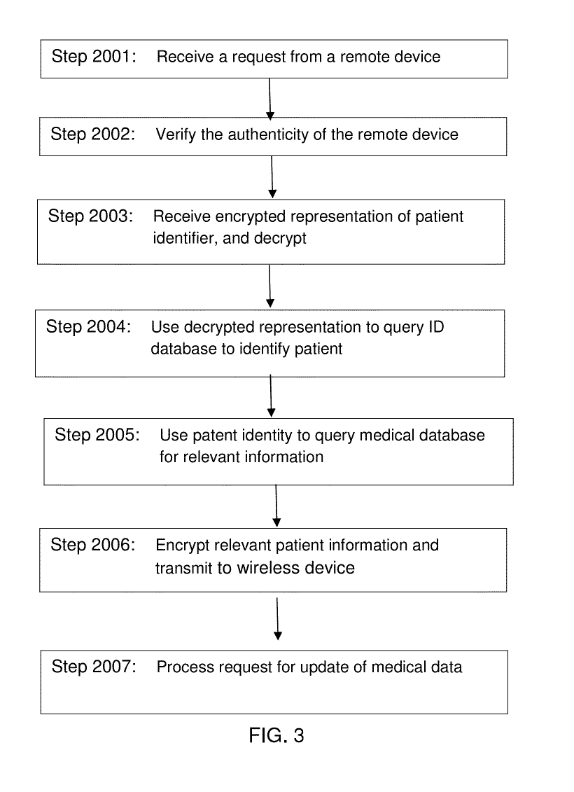

FIG. 3 shows a schematic flow diagram of some of the steps of a method for securely accessing medical data that may be performed on a remote server.

Step 2001: Receive a request from a remote device. The server application 180 may use the remote secure data center server 150 to receive and process a request for identification and information relayed to it via a wireless network 118.

Step 2002: Verify the authenticity of the remote device. In a preferred embodiment, the server application 180 may first authenticate the request. This may, for instance, consist of a standard challenge/response authentication such as, but not limited to, requesting a username and password. Such a standard authentication procedure may be sufficient to ensure that the medical practitioner 175 making the request is authorized to make the request. The authentication may also, or instead, identify the wireless device 115 by obtaining a device's unique identifier that may be a number such as, but not limited to, its Android ID, its UDID, its international mobile equipment identify (IMEI) or its international mobile subscriber identity (IMSI) or some combination thereof. The relevant ID number may then, for instance, be compared against a database of pre-registered device numbers.

Step 2003: Receive an encrypted representation of a patient identifier, and decrypt. The server application 180 may use the remote secure data center server 150 to receive an encrypted representation 140 of the patient identifier 130 and decrypt it to produce a decrypted representation 142. The original encryption by the wireless device 115 may have used the remote secure data center server's 150 public key. The decryption may now be done using the remote secure data center server's 150 private key, as is standard practice in Internet transactions and as implemented by applications such as, but not limited to, online shopping carts.

Step 2004: Use the decrypted representation to query an ID database to identify the patient. The server application 180 may use the remote secure data center server 150 to identify the patient using the decrypted representation 142. The identification may attempt to find a match, or find the closest match, between the decrypted representation 142 of the patient identifier 130 and stored representations in a database. In a preferred embodiment, this may mean attempting to match the patient's finger-print with a database of known finger-prints. This matching may be attempted using any standard file matching technique such as, but not limited to, image pattern matching using correlations, feature matching or image edit-distance matching, or some combination thereof.

If a match is not found, or is ambiguous, or is below a certain threshold of certainty, this information may be reported back to the medical practitioner 175 via the wireless device 115 so that further options may be explored, or instructions given. The further options may, for instance, include repeating the data capture using either the same or another form of data capture, using another portion of the patient for the data capture, or responding to one or more specific questions regarding visible physical features of the patient such as, but not limited to, sex, height, weight, eye or hair color, or some combination thereof. One possible parameter that may be used in the identification process is the location of the wireless device. It is preferable that the wireless device contains or connects to a GPS element, enabling the identification of the GPS location of the wireless device. As an optional condition, if the wireless device is within a pre-set geographic area, a positive identification may be made. Otherwise, the access to the medical data may be denied.

Step 2005: Use the patient's identity to query a medical database for relevant information. If a reliable identification has been made, the server application 180 may use the remote secure data center server 150 to obtain relevant medical data 160 from the secure database of patient medical data 190.

Step 2006: Encrypt the relevant patient information and transmit that to the wireless device. Having obtained the required medical data, the server application 180 may use the remote secure data center server 150 to encrypt the data to produce the encrypted medical data 164. The encrypted medical data 164 may then be transmitted back to the wireless device 115 via the wireless network 118.

Step 2007: Process request for update of medical data. The server application 180, after the previous authentication, may continue to process an update request, if one is sent by the patient. The server application 180 may determine that more recent information is available so that the medical record on file can be updated. Moreover, if the patient manages to send in medical information regarding himself/herself, the server application 180 may process such information, add it to the patient's medical record, and re-send the updated medical data to the wireless device 115 via the wireless network 118.

One extra step for the current method includes an overriding mechanism. Override may be enabled by using the patient's input of password, or other verbal or bio-sensor. The patient may also allow a trusted person, such as a friend or family member, to override the identification process, or associate that person's biometric data with the identification for the access of the medical data. Such an arrangement may pose some security risks, but may also prevent tragedies and/or inconveniences when the patient's own biometric identifier may not be easily obtained. Such an arrangement may also serve as a backup plan if somehow the regular process cannot go through as expected.

As outlined above, in a preferred embodiment, data capture, i.e., obtaining the finger-print 210, may be performed using a suitably high-resolution OLED matrix display 510. The reason this may be done is that light emitting diodes—both solid state and organic—can be made to operate both as light absorbers and as light emitters. Although the light absorbing propertied have only played a minor role in the use of solid state LEDs, the light absorbing qualities of OLED matrixes is, apparently, being studied seriously by DARPA for use in low cost night vision glasses. (In that application, the OLED matrixes are designed to absorb infra-red light and the current generated may then be used to power visible light OLEDs).

To understand how the OLED display may be used as a proximity camera, it may be useful to consider the two bias modes of an LED.

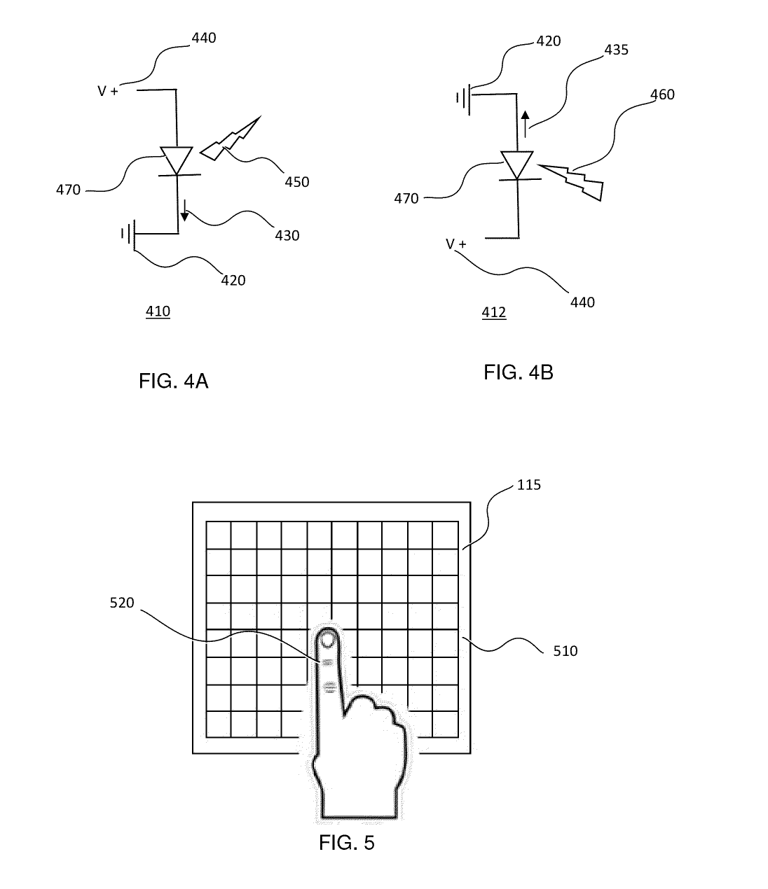

FIG. 4A shows a positively biased Light Emitting Diode (LED) producing emitted light. In this mode, the light emitting diode (LED) 470 is oriented between the positive potential 440 and the ground potential 420 so that the direction of current flow 430 is through the diode. With current flowing through the light emitting diode (LED) 470, it acts as a light emitter, generating emitted light 450.

FIG. 4B shows a reverse biased Light Emitting Diode (LED) absorbing light. In this mode, the light emitting diode (LED) 470 is oriented between the positive potential 440 connection and the ground potential 420 so that current flow through the diode is prevented.

However, if light of the appropriate wavelength is incident on the LED while it is biased in this manner, the incident light becomes absorbed light 460 and generates a current. The direction of generated current flow 435 is shown.

An LED in a positively biased configuration 410 may effectively be transformed to being in a reverse biased state 412 by having the positive potential 440 replaced with a negative potential. By driving the voltage controlling a particular pixel from positive (emitting light) to negative (absorbing light), it may be changed from an emitter to a detector. If this is done substantially simultaneously—and sufficient quickly—for all the pixels of an LED or OLED matrix display, and the current generated from each pixel obtained, the display may be used as a simple flash proximity-camera. Such a flash proximity-camera may obtain an image of an object that is on the display screen surface.

FIG. 5 shows an OLED matrix display that may capture a fingerprint.

The wireless device 115 has an OLED matrix display 510 having a resolution greater than 250 ppi. A patient's finger 520 is placed on the screen. All the pixels of the display are first biased positive and emit light. All the pixels of the display are then rapidly biased negative, and the currents produced by each pixel are collected. The magnitude of the current of each pixel now represents how much light was reflected back into that pixel. With appropriate timing and emission levels, an image of an object in contact may be formed at a resolution approaching the pixel level of the display screen.

The current Samsung Galaxy 5™ smartphone has an OLED matrix display 510 with a resolution greater than 300 pixels per inch. A suitably programmed application may, therefore, be able to use such a smartphone display to obtain proximity images of finger-prints at a resolution sufficient for identification purposes.

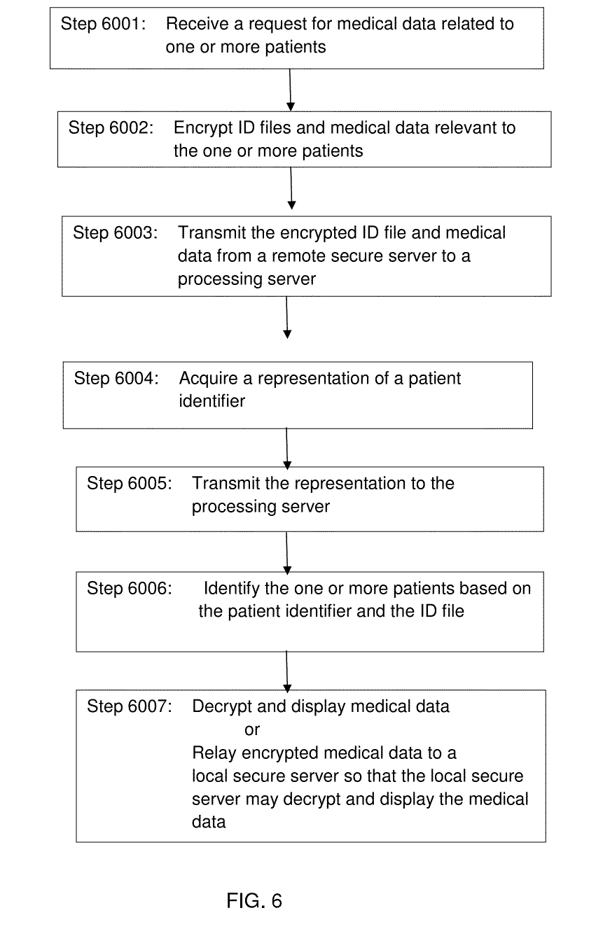

FIG. 6 shows a schematic flow diagram of some of the steps of a modified method for securely accessing medical data. The method, as another preferred embodiment of the current invention, differs from the methods generally described in FIGS. 1-3 in that the encrypted medical data is transferred to a processing server before the identification process is completed. However, similar to the methods described above, the embodiment shown in FIG. 6 only allows decryption and display of the encrypted medical data after the identification of the patient or patients. Nevertheless, it should be noted that some elements of this particular embodiment has been discussed above and such discussions are considered to be included herein except when they contradict with the disclosures specifically made for the FIG. 6 embodiment. For instance, though it is not expressly stated, the method in FIG. 6 also includes an optional step that the patient or authorized health professional may review the received medical record and upon the discovery of any inadequacy, make a request to update the medical data. In addition, overriding mechanisms may be employed to overcome emergency situations when the regular identification approaches are not successful.

Step 6001: Receive a request for medical data related to one or more patients. For example, a emergency medical center may receive phone calls from an individual associated with a patient or a number of patients, stating that medical records are needed.

Step 6002: Encrypt ID files and medical data relevant to the one or more patients. The encryption is likely to be performed by a remote secure server, which may access the database storing the medical data and the identification (ID) files for the intended patient(s). Since in Step 6001 there is no verification of the identity of the person making the request, the access to the encrypted medical data is closely controlled. The ID files cover the biometrics or other data that may be used to determine the identity of the patient(s). Alternatively, the ID files can be transferred to the processing server without encryption. As long as the ID files can only be accessed by authorized personnel, there is little risk of unintended disclosure.

Step 6003: Transmit the encrypted ID files and medical data from a remote secure server to a processing server. One example is that the encrypted ID files and medical data may be transmitted to an ambulance or a medivac helicopter. The benefit of such “early” transmission or “pushing” of the medical data is that after such a transmission networking capacities are no longer absolutely necessary. For instance, if the ambulance or the medivac helicopter is setting out to a remote region having no network access, the medical data will still be available when the ambulance or helicopter arrives, though decryption will be performed only after a positive identification can be made.

Step 6004: Acquire a representation of a patient identifier. This acquisition of the representation of the patient identifier is described in detail for the other embodiments and the processes are essentially the same. The representation, in most cases, does not need to be encrypted because it is used right away for the identification of one or more patients. However, it is also possible that representation of the patient identifier needs to be encrypted to ensure higher level of security.

Step 6005: Transmit the representation to the processing server. It should be noted that the term “transmit” should be understood in the most general sense. It can be wired or wireless transmission. It covers any conveyance of information or any subject matter. Here the representation may be transmitted to the processing server through a wireless network or through wired transfer. Or the device to acquire the representation is simply a part of the processing server, making the transmission even more direct and efficient.

Step 6006: Identify the one or more patients based on the patient identifier and the ID files. This step is partially described in detail for the other embodiments. As indicated above, the ID files from the database may or may not be encrypted. If the ID files are encrypted, they should be decrypted first before identification can be made. It should also be noted that in addition to biometric data the patient or patient or individual who made the request may initiate the decrypting process by other means, such as inputting a password using a keyboard or other inputting devices. The password needs to be set before hand by the patient or patients.

Step 6007: The processing server may decrypt the encrypted medical data. Then the processing server may display the decrypted medical data or transfer the decrypted medical data to a local server. Alternatively, the processing server may relay the encrypted medical data to a local secure server so that the local secure server may decrypt and display the medical data. This step provides significant flexibility to the current method. For example, if an ambulance breaks down on its way while encrypted medical data is in the processing server on board the ambulance, the data may be transferred to another ambulance for further decryption and/or display. In this particular case, if network is maintained, the other ambulance also has the option to receive encrypted medical data from the remote secure server, ensuring a higher level of security.

In addition to the variations indicated above for the embodiment shown in FIG. 6, other alternations that are disclosed for the other embodiment may also apply. For example, the processing server may be the same device that acquires the representation of the patient identifier. Moreover, the identification may be made locally without the need to transfer the ID files to the processing server. In that case the ID files are preloaded so that the processing server may be used for identification for a large number of people, while only the ones with a positive identification will gain access to their medical data.

Although this application has been described primarily with respect to finger-print identification, one of ordinary skill in the art will readily appreciate that other biometric methods may be used to implement the method of this invention such as, but not limited to, voice recognition and vein recognition, or a combination thereof.

Voice recognition is described in detail in, for instance, U.S. Pat. No. 4,587,670 issued to Levinson et al on May 6, 1986 entitled “Hidden Markov model speech recognition arrangement”, and in U.S. Pat. No. 7,831,426 issued to Bennett on Nov. 9, 2010 entitled “Network based interactive speech recognition system”, the contents of both of which are hereby incorporated by reference.

Vein recognition is described in detail in, for instance, U.S. Pat. No. 7,526,111 issued to Miura et al. on Apr. 28, 2009 entitled “Personal identification device and method”, the contents of which are hereby incorporated by reference.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1: A method for securely accessing medical data, comprising:
providing a device application, running on an electronic device, said device application comprising instructions to enable said electronic device to perform one or more functions comprising:
acquiring a representation of a patient identifier, and wherein said representation of a patient identifier has a resolution sufficient to determine identity of a patient;
encrypting said representation of a patient identifier to produce an encrypted representation;
transmitting said encrypted representation to a processing server for identity confirmation;
automatically identifying at least one patient using said representation of said patient identifier by a server application operable on said processing server;
receiving encrypted medical data from a remote secure data server, said medical data being representative of data related to said at least one patient, said data having been automatically retrieved from a secure patient database; and
decrypting said medical data to provide decrypted medical data.

2: The method of claim 1, wherein the electronic device is a wireless device connected to a network.

3: The method of claim 2, wherein the wireless device is connected to a Wireless Personal Area Network, a Wireless Local Area Network, a Wireless Mesh Network, a Wireless metropolitan area network, a Wireless Wide Area Network, a Cellular Network, or other securable data sharing networks.

4: The method of claim 1, wherein the electronic device includes a biometric sensor and the biometric sensor acquires the representation of the patient identifier.

5: The method of claim 4, wherein the biometric sensor includes a light emitting diode (LED) or organic light emitting diode (OLED) display, and the representation of the patient identifier is acquired by putting the patient identifier substantially in contact with said LED or OLED display.

6: The method of claim 1, wherein the electronic device is connected to a biometric sensor and the biometric sensor acquires the representation of the patient identifier.

7: The method of claim 6, wherein the biometric sensor includes a light emitting diode (LED) or organic light emitting diode (OLED) display, and the representation of the patient identifier is acquired by putting the patient identifier substantially in contact with said LED or OLED display.

8: The method of claim 1, wherein the electronic device includes a keyboard for password input.

9: The method of claim 1, wherein the representation of the patient identifier is pre-processed to prepare for comparison to data stored in a database.

10: The method of claim 1 wherein said patient identifier is a finger-print.

11: The method of claim 10 wherein said representation of said patient's finger print has a resolution greater than or equal to 250 pixels per inch.

12: The method of claim 1, wherein the processing server is the electronic device.

13: The method of claim 12, further comprising the steps: the electronic device transmitting an identification confirmation signal to the remote secure data server.

14: The method of claim 13, wherein the electronic device is a wireless device.

15: The method of claim 13, wherein the electronic device is a PDA, tablet, or other portable electronic device.

16: The method of claim 1, wherein the processing server is the remote secure data center server.

17: The method of claim 16, wherein said data is automatically retrieved from said secure patient database by said server application operable on said remote secure data server.

18: The method of claim 1 wherein access to said decrypted medical data is made available to a local secure server.

19: The method of claim 18, wherein said local secure server is said electronic device.

20: The method of claim 19 wherein said decrypted medical data is displayed, by said electronic device, in a human accessible form.

21: The method of claim 20 wherein said human accessible form is one of an audio, an image and a human readable alpha-numeric script, or a combination thereof.

22: The method of claim 1, further comprising the steps: making a positive identification by the processing server using the encrypted representation; and generating a decryption key for the medical data only if the positive identification is made.

23: The method of claim 22, wherein said decryption key is encrypted together with said representation of a patient identifier.

24: The method of claim 23, wherein said decryption key is time coded with an expiration time.

25: The method of claim 23, wherein said decryption key is encoded with a GPS footprint or WiFi connecting data.

26: The method of claim 22, wherein the processing server is a local server.

27: The method of claim 1 wherein said encrypting and decrypting comprises use of RSA private and public keys.

28: The method of claim 1 wherein said electronic device is a smartphone, a note-pad computer, a tablet-based device, an e-book reader, or some combination thereof, standlone or in combination with an external biometric scanner.

29: The method of claim 1 wherein said wireless access comprises one of a cellphone connection, a WiFi connection and a BlueTooth connection, any equivalent standard connection the delivers data connectivity, or some combination thereof.

30: The method of claim 1, further comprising the steps of examining the decrypted medical data and sending in a request for an update of the medical data.

31: The method of claim 1, further comprising the steps of making a positive identification and sending a notification to an identified medical professional.

32: The method of claim 1, further comprising the step that the patient configuring the server application to allow sending a notification to an identified medical professional after a positive identification is made.

33: The method of claim 1 wherein said automated identification of said at least one patient comprises comparing said representation of said patient's finger print with a database of recorded finger prints using a pattern recognition method or an image edit distance method, or some combination thereof.

34: A method for securely distributing patient medical data, comprising:
providing a server application, running on a secure data center server, said server application comprising instructions to enable said secure data center server to perform one or more functions comprising:
receiving a request from a remote electronic device;
verifying the identity of the electronic device and of an operator using the electronic device;
confirming that both the device and operator are authorized to contact the secure data center server for the medical data of third parties;
receiving and decrypting an encrypted representation of a patient identifier sent from said authorized, remote electronic device to provide a decrypted representation;
using said decrypted representation to automatically identify said third party;
confirming that the identified electronic device and operator are both authorized to receive some or all of the medical data relevant to said identified third party;
obtaining relevant, authorized medical information related to said third party;
encrypting said relevant, authorized medical data; and
transmitting said encrypted relevant, authorized, medical data to said authorized electronic device.

35. The method of claim 34, further comprising the step: identifying a GPS location of the electronic device and/or the operator, using the GPS location to verify the identity of the electronic device and of the operator using the electronic device.

36: The method of claim 34, further comprising the step: transmitting said encrypted relevant, authorized, medical data to devices other than said authorized electronic device.

37: The method of claim 34, wherein the electronic device is a wireless device.

38: The method of claim 34, further comprising the step of processing a request to update the relevant, authorized, medical data.

39: The method of claim 1 wherein said medical data received from the remote secure server is encrypted.

40: The method of claim 39 wherein said encrypted medical data is decrypted by a local server.

41: The method of claim 40, wherein said local server is said electronic device.

42: The method of claim 40, wherein said local server is co-located with said electronic device.

43: The method of claim 2 wherein said wireless device comprises a touch input screen having an array of piezo-electric elements that provide said representation.

44: The method of claim 43 wherein said touch input screen comprises an array of capacitive elements that provide said representation.

45: The method of claim 2 wherein said wireless device is a camera-equipped wireless device.

46: The method of claim 1 wherein said patient identifier is any biometric data capable of playing a role in determining the patient's identity through any signaling means.

47: The method of claim 46, wherein said biometric data is imageable biometric data.

48: The method of claim 46, wherein said biometric data is sound-based biometric data.

49: The method of claim 1 wherein said patient identifier is any chip-based recognition capable of playing a role in determining the patient's identity.

50: The method of claim 1, further comprising the steps of examining the decrypted medical data and sending in a request for an update of the medical data.

51: The method of claim 1, further comprising the step: said patient determining and configuring access to the data related to said patient.

52: The method of claim 1, further comprising the steps: overriding the automatic identification by a pre-approved means of authorization.

53: The method of claim 1, further comprising the step: transmitting said decrypted medical data to local devices other than said electronic device.

54: A method for securely distributing patient medical data, comprising:
receiving a request for medical data related to one or more patients;
encrypting ID files and medical data relevant to the one or more patients;
transmitting the encrypted ID files and medical data from a remote secure server to a processing server;
acquiring a representation of a patient identifier;
transmitting the representation to the processing server;
identifying the one or more patients based on the patient identifier and the ID files;

55: The method of claim 54, further comprising the step: the processing server decrypting the encrypted medical data.

56: The method of claim 55, further comprising the step: the processing server transmitting the decrypted medical data to a local server.

57: The method of claim 54, further comprising the steps: relaying the encrypted medical data to a local secure server; the local secure server decrypting and displaying the encrypted medical data.
